(19) United States
(12) Patent Application Publication
(10) Pub. No.: US 2024/0101485 A1
(43) Pub. Date: Mar. 28, 2024

(54) POWDER COMPOSITION AND MANUFACTURING METHOD THEREOF

(71) Applicant: NAN YA PLASTICS CORPORATION, Taipei (TW)

(72) Inventors: Te-Chao Liao, Taipei (TW); Hung-Yi Chang, Taipei (TW); Chia-Lin Liu, Taipei (TW)

(73) Assignee: NAN YA PLASTICS CORPORATION, Taipei (TW)

(21) Appl. No.: 17/987,801

(22) Filed: Nov. 15, 2022

(30) Foreign Application Priority Data
Sep. 22, 2022 (TW) 111135985

(51) Int. Cl. C04B 35/628; C08K 5/5415

(52) U.S. Cl. CPC C04B 35/62849; C04B 35/62852; C08K 5/5415

(57) ABSTRACT

A powder composition includes a first powder, a second powder, and a modified functional group. A particle size range of the first powder is between 1 micron and 100 microns. The second powder and the modified functional group are modified on the first powder. A particle size range of the second powder is between 10 nanometers and 1 micron. A manufacturing method of a powder composition is also provided.

### CROSS-REFERENCE TO RELATED APPLICATION

This application claims the priority benefit of Taiwan application serial no. 111135985, filed on Sep. 22, 2022. The entirety of the above-mentioned patent application is hereby incorporated by reference herein and made a part of this specification.

### BACKGROUND

### Technical Field

The disclosure relates to a composition and a manufacturing method thereof, and more particularly, to a powder composition and a manufacturing method thereof.

### Description of Related Art

Currently, in the field of the fifth generation (5G) electronics, due to the increase in power and frequency, a new form of substrate with low dielectric loss, high heat dissipation, and good peel strength is required. Furthermore, inorganic filler is often used in substrate materials. Since inorganic filler often lacks the bonding capability with resin and a copper foil, problems such as poor water absorption, poor substrate peel strength, etc. are prone to occur, thereby reducing the stability and reliability of the substrate.

### SUMMARY

The disclosure provides a powder composition and a manufacturing method thereof, which may effectively improve the stability and reliability of a substrate produced by the powder composition.

A powder composition of the disclosure includes a first powder, a second powder, and a modified functional group. A particle size range of the first powder is between 1 micron and 100 microns. The second powder and the modified functional group are modified on the first powder. A particle size range of the second powder is between 10 nanometers and 1 micron.

In an embodiment of the disclosure, the above-mentioned modified functional group includes a vinyl group, an acrylic group, an epoxy group or a maleic anhydride, an amine group or a combination thereof.

In an embodiment of the disclosure, the above-mentioned first powder includes a ceramic particle, a metal particle or a combination thereof.

In an embodiment of the disclosure, the above-mentioned ceramic particle includes silicon dioxide, aluminum oxide, silicon nitride, aluminum nitride, aluminum silicate, calcium silicate, boron nitride, silicon carbide, titanium dioxide, strontium titanate, calcium titanate or a combination thereof, and the metal particle includes copper, aluminum, titanium, indium or a combination thereof.

In an embodiment of the disclosure, the above-mentioned second powder includes a ceramic particle, a metal particle or a combination thereof.

In an embodiment of the disclosure, the above-mentioned ceramic particle includes silicon dioxide, aluminum oxide, silicon nitride, aluminum nitride, aluminum silicate, calcium silicate, boron nitride, silicon carbide, titanium dioxide, strontium titanate, calcium titanate or a combination thereof, and the metal particle includes copper, aluminum, titanium, indium or a combination thereof.

A manufacturing method of a powder composition of the disclosure at least includes the following steps. A first powder is provided. A second powder and a modified functional group are modified on the first powder.

In an embodiment of the disclosure, after the above-mentioned modification, performing high-temperature vacuum sintering is further included.

In an embodiment of the disclosure, the above-mentioned manufacturing method of the powder composition further includes bonding a compound having the modified functional group to the first powder by a chemical vapor deposition, chemical modification or physical mixing method.

In an embodiment of the disclosure, the above-mentioned compound is a siloxane coupling agent.

Based on the above, in the disclosure, through the design that the second powder and the modified functional group are modified on the first powder, and the particle size range of the second powder (between 10 nanometers and 1 micron) is smaller than the particle size range of the first powder (between 1 micron and 100 microns), the bonding capability between the powder composition, resin, and a copper foil is improved, and the related physical properties (such as thermal conductivity, water absorption, peel strength, heat resistance or dielectric constant (Dk)/dielectric loss (DO performance, etc.), are improved, which may further improve the stability and reliability of a substrate produced by the powder composition.

In order to make the aforementioned features and advantages of the disclosure comprehensible, embodiments are described in detail as follows.

### DESCRIPTION OF THE EMBODIMENTS

In the embodiment, a powder composition includes a first powder, a second powder, and a modified functional group. In addition, in the disclosure, through the design that the second powder and the modified functional group are modified on the first powder, and the particle size range of the second powder (between 10 nanometers and 1 micron) is smaller than the particle size range of the first powder (between 1 micro and 100 microns), the bonding capability between the powder composition, resin, and a copper foil is improved, and the related physical properties (such as thermal conductivity, water absorption, peel strength, heat resistance or dielectric constant (Dk)/dielectric loss (DO performance, etc.), are improved, which may further improve the stability and reliability of a substrate produced by the powder composition. Here, the use ratio of the first powder in the powder composition may be between 30 wt % and 70 wt %, and the use ratio of the second powder in the powder composition may be between 0.5 wt % and 5 wt %.

In an embodiment, the modified functional group includes vinyl, acrylic, epoxy or maleic anhydride, amino or a combination thereof, but the disclosure is not limited thereto.

In an embodiment, the first powder includes a ceramic particle, a metal particle, or a combination thereof. For example, the ceramic particle includes silicon dioxide, aluminum oxide, silicon nitride, aluminum nitride, aluminum silicate, calcium silicate, boron nitride, silicon carbide, titanium dioxide, strontium titanate, calcium titanate or a combination thereof, and the metal particle includes copper, aluminum, titanium, indium or a combination thereof, but the disclosure is not limited thereto.

In an embodiment, the second powder includes a ceramic particle, a metal particle, or a combination thereof. For example, the ceramic particle includes silicon dioxide, aluminum oxide, silicon nitride, aluminum nitride, aluminum silicate, calcium silicate, boron nitride, silicon carbide, titanium dioxide, strontium titanate, calcium titanate or a combination thereof, and the metal particle includes copper, aluminum, titanium, indium or a combination thereof, but the disclosure is not limited thereto.

In an embodiment, the first powder may be the same as the second powder, but the disclosure is not limited thereto. In another embodiment, the first powder may be different from the second powder, and the first powder and the second powder may be determined according to actual design requirements. In addition, the first powder and the second powder may be any inorganic filler suitable for substrate fabrication.

In addition, in the embodiment, a manufacturing method of a powder composition includes at least the following steps. A first powder is provided, and a second powder and a modified functional group are modified on the first powder. For example, the manufacturing method may include the following steps. First, the first powder and the second powder are mixed, and the mixing method is, for example, wet high-speed mixing or dry high-speed mixing. Next, a compound having the modified functional group is bonded to the above-mentioned powder (the first powder) mixed by a chemical vapor deposition, chemical modification or physical mixing method, so that the modified functional group is bonded. The compound may be a siloxane coupling agent, and the chemical modification method is, for example, a modification by a suitable electrochemical pretreatment method. The electrochemical pretreatment method may be known to those skilled in the art, and details are not described herein again. Then, the above-mentioned mixed powder of the bonded modified functional group may be sintered at high temperature to generate a more stable heterogeneously combined powder composition. According to this, the production of the powder composition has been roughly completed, but the powder composition of the disclosure is not limited to the above manufacturing method. As long as a second powder and a modified functional group may be modified on a first powder, all of which falls within the protection scope of the disclosure. For example, the manufacturing process of the powder composition may further include procedures such as homogenization, de-aeration, centrifugation, and heating.

In an embodiment, the siloxane coupling agent includes Z-6030.

The following examples and comparative examples are given to illustrate the effects of the disclosure, but the scope of claims of the disclosure is not limited to the scope of the examples.

The copper foil substrates produced in the respective examples and comparative examples were evaluated according to the following method.

A thermal conductivity analysis test: Interface material thermal resistance and thermal conductivity measuring instruments were used.

Copper foil peel strength (1b/in): The peel strength between a copper foil and a circuit carrier was tested.

Water absorption (%): After the sample was heated in a pressure cooker at 120° C. and 2 atm for 120 minutes, the weight change before and after heating was calculated.

Solder heat resistance at 288° C. (seconds): The sample was heated in a pressure cooker at 120° C. and 2 atm for 120 minutes and then immersed in a solder furnace at 288° C., and the time required for the sample to explode and delaminate was recorded.

A dielectric constant Dk: The dielectric constant Dk at a frequency of 10 GHz was measured by a dielectric analyzer (E4991A) of Agilent Technologies.

A dielectric loss Df: The dielectric loss Df at a frequency of 10 GHz was measured by the dielectric analyzer (E4991A) of Agilent Technologies.

### Example 1, Comparative Example 1

The resin composition shown in Table 1 was mixed with toluene to form a varnish of thermosetting resin composition. After the above-mentioned varnish was impregnated with Nanya fiberglass cloth (Nanya Plastics Co., Ltd., cloth type 1078) at room temperature, and then dried at 110° C. (an impregnation machine) for a few minutes, a prepreg with a resin content of 76 wt % was obtained. Finally, four pieces of prepreg were stacked between two 35 μm thick copper foils, maintained at a constant temperature for 20 minutes under a pressure of 25 kg/cm 2 and a temperature of 85° C., then heated to 185° C. at a heating rate of 3° C./min, maintained at a constant temperature for 120 minutes, and then slowly cooled to 130° C. to obtain a 0.8 mm thick copper foil substrate. It should be noted that silicon dioxide (type SS15V) in Table 1 is a micron-sized powder, which may be used optionally to improve heat resistance, and to modify boron nitride powder with nano-alumina, the nano-alumina (a second powder, of which the particle size is 10 nanometers to 50 nanometers) and a siloxane coupling agent (silane 26030) may be physically mixed first to form a bond, which is then physically mixed with the boron nitride powder (a first powder, of which the particle size is 35 microns), so that the nano-scale alumina may be adsorbed on the boron nitride powder, and then a modified functional group (derived from silane) may be modified to the boron nitride powder.

The physical properties of the prepared copper foil substrates were tested, and the results are shown in Table 1. After comparing the results of Example 1 and Comparative Example 1 in Table 1, the following conclusions may be drawn: compared with the substrate produced by the conventional powder composition (Comparative Example 1), the substrate produced by the powder composition of the disclosure (Example 1) may improve the related physical properties (such as thermal conductivity, water absorption, peel strength, heat resistance or Dk/Df performance, etc.), and may further improve the stability and reliability of the substrate produced by the powder composition of the disclosure.

TABLE 1

| | | Example | | Comparative Example | |
|---|---|---|---|---|---|
| Parts by weight (%) | | 1 | | 1 | |
| Resin | Liquid rubber resin (RICON-257) | 20 | wt % | 20 | wt % |
| | Polyphenylene ether resin | 10 | wt % | 10 | wt % |
| | (SA9000) | | | | |
| Crosslinking agent | TAIC | 10 | wt % | 10 | wt % |
| Accelerator | DCP | 1.5 | phr | 1.5 | phr |
| Other additives | Z6030 | 1 | phr | 1 | phr |
| (coupling agent) | | | | | |
| Powder | Silicon dioxide (SS15V) | 28 | wt % | 28 | wt % |

| | | | | |
|---|---|---|---|---|
| composition | Unmodified boron nitride powder | — | 32 | wt % |

| SA35 (D50 = 35 um) | | | |
|---|---|---|---|
| Modify boron nitride powder with | 32 | wt % | — |

nano-alumina

| | | |
|---|---|---|
| Thermal conductivity (W/mK) | 1.25 | 1.15 |
| Peel strength (lb/in) | 6 | 3 |
| Water absorption (%) | 0.14 | 0.56 |
| Heat resistance | Pass | NG |
| Dielectric constant (Dk)/Dielectric loss (Df) | 3.77/0.0028 | 3.86/0.0038 |

It should be noted that the powder composition of the disclosure may be used to form a desired substrate with any suitable resin and copper foil according to actual design requirements, which is not limited in the disclosure.

To sum up, in the disclosure, through the design that the second powder and the modified functional group are modified on the first powder, and the particle size range of the second powder (between 10 nanometers and 1 micron) is smaller than the particle size range of the first powder (between 1 micron and 100 microns), the bonding capability between the powder composition, resin, and a copper foil is improved, and the related physical properties (such as thermal conductivity, water absorption, peel strength, heat resistance or Dk/Df performance, etc.), are improved, which may further improve the stability and reliability of a substrate produced by the powder composition.

Although the disclosure has been described with reference to the above embodiments, the described embodiments are not intended to limit the disclosure. People of ordinary skill in the art may make some changes and modifications without departing from the spirit and the scope of the disclosure. Thus, the scope of the disclosure shall be subject to those defined by the attached claims.

What is claimed is:

1. A powder composition, comprising:
a first powder, wherein a particle size range of the first powder is between 1 micron and 100 microns;
a second powder, modified on the first powder, wherein a particle size range of the second powder is between 10 nanometers and 1 micron; and
a modified functional group, modified on the first powder.

2. The powder composition according to claim 1, wherein the modified functional group comprises a vinyl group, an acrylic group, an epoxy group or a maleic anhydride, an amine group or a combination thereof.

3. The powder composition according to claim 1, wherein the first powder comprises a ceramic particle, a metal particle or a combination thereof.

4. The powder composition according to claim 3, wherein the ceramic particle comprises silicon dioxide, aluminum oxide, silicon nitride, aluminum nitride, aluminum silicate, calcium silicate, boron nitride, silicon carbide, titanium dioxide, strontium titanate, calcium titanate or a combination thereof, and the metal particle comprises copper, aluminum, titanium, indium or a combination thereof.

5. The powder composition according to claim 1, wherein the second powder comprises a ceramic particle, a metal particle or a combination thereof.

6. The powder composition according to claim 5, wherein the ceramic particle comprises silicon dioxide, aluminum oxide, silicon nitride, aluminum nitride, aluminum silicate, calcium silicate, boron nitride, silicon carbide, titanium dioxide, strontium titanate, calcium titanate or a combination thereof, and the metal particle comprises copper, aluminum, titanium, indium or a combination thereof.

7. A manufacturing method of a powder composition, comprising:
providing a first powder; and
modifying a second powder and a modified functional group on the first powder.

8. The manufacturing method of the powder composition according to claim 7, wherein after the modification, performing high-temperature vacuum sintering is further comprised.

9. The manufacturing method of the powder composition according to claim 7, further comprising bonding a compound having the modified functional group to the first powder by a chemical vapor deposition, chemical modification or physical mixing method.

10. The manufacturing method of the powder composition according to claim 9, wherein the compound is a siloxane coupling agent.
